(19) United States
(12) Patent Application Publication
(10) Pub. No.: US 2007/0078052 A1
(43) Pub. Date: Apr. 5, 2007

(54) Methanol tolerant catalyst material

(76) Inventors: Vitali Arkad'evich Grinberg, Moscow (RU); Tat'jana L'vovna Kulova, Moscow (RU); Alexander Mordukhaevich Skundin, Moscow (RU); Alexander Anatol'evich Pasynskii, Moscow (RU)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/245,268

(22) Filed: Oct. 5, 2005

(30) Foreign Application Priority Data
Oct. 5, 2004 (RU) 2004129396

(51) Int. Cl. B01J 21/18; B01J 31/00

(52) U.S. Cl. 502/150; 502/152; 502/159; 502/185

(57) ABSTRACT

Methanol tolerant catalyst material and method of its preparation are provided. These novel catalyst materials are based on organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2. The catalyst materials are obtained by mixing together organometallic clusters of definite composition with an electrically conductive component in an organic solvent, subsequent removing of the solvent, and in a non-oxidizing environment, heat-treating the clusters adsorbed on the electrically conductive component at the temperature of at least 175° C.

### FIELD OF THE INVENTION

The present invention relates in general to catalysts useful for catalytic oxygen reduction reactions, and more particularly, to methanol tolerant electrocatalysts useful as cathode material for the electro-reduction of oxygen in direct methanol fuel cells.

### BACKGROUND OF THE INVENTION

Based on rapidly expanding needs for power generation and the desire to reduce the use of hydrocarbon fuels as well as a reduction in polluting emissions, fuel cells are expected to fill an important role in applications such as transportation and utility power generation. Fuel cells are highly efficient devices producing very low emissions, have a potentially renewable fuel source, and convenient refueling. Fuel cells convert chemical energy to electrical energy through the oxidation of fuels such as hydrogen or methanol to form water and carbon dioxide. Hydrogen fuel, however, presents serious storage and transportation problems. For these reasons, significant attention has been paid to the development of liquid fuel based fuel cells, and more particularly, to fuel cells in which methanol is fed directly to the fuel cell without any pre-treatment, i.e., direct methanol fuel cells (DMFCs). Without the need of a chemical pre-processing stage, methanol fuel is fed directly to the fuel cell. Also, other bulky accessories are not needed. This simplicity in design and construction make DMFC suitable for many applications requiring portable power supplies.

Electrochemical fuel cells convert fuel and oxidant to electricity and reaction products. Fluid reactants are supplied to a pair of electrodes that are in contact with and separated by an electrolyte. The electrolyte may be a solid or a liquid, i.e., a supported liquid matrix. Solid electrolytes are comprised of solid ionomer or ion-exchange membrane disposed between two planar electrodes. The electrodes typically comprise an electrode substrate and an electrocatalyst layer disposed upon a major surface of the substrate. The electrode substrate typically comprises a sheet of porous, electrically conductive material, such as carbon cloth or carbon fiber paper. The electrode catalyst is typically in the form of finely comminuted metal, such as platinum, and is disposed on the surface of the electrode substrate in order to induce the desired electrochemical reaction. In a single cell, the electrodes are electronically coupled to provide a path for conducting electrons through an external load thereby producing electric current.

In a direct methanol fuel cell the reactions taking place at the anode, cathode, and the overall reaction are given below:

Anode Reactions:

(i)
   CH₃OH→COH_{ads}+3H_{ads}; (1)
(ii) anodic oxidation of adsorbed hydrogen:
   3H_{ads}→3H⁺+3e; (2)
(iii) adsorption of some oxygen-containing species:
   3H₂O→3OH_{ads}+3H++3e; (3)
(iv) interaction of the adsorbed species and their removal from the surface:
   COH_{ads}+3OH_{ads}→CO₂↑+2H₂O. (4)

The consecutive and parallel combination of the steps (i)-(iv) gives overall anode reaction:
CH₃OH+H₂O→CO₂↑+6H⁺+6e. (5)
Cathode reaction:
   O₂+4H⁺+4e→2H₂O
Overall cell reaction:
   CH₃OH+1.5O₂→CO₂+2H₂O

The protons formed at the anode electrocatalyst migrate through the ion-exchange membrane from the anode to the cathode, while the electrons flow through an external load. At the cathode, the oxidant (oxygen) reacts with the protons to form water. In these fuel cells, crossover of a reactant from one electrode to the other is undesirable. Reactant crossover may occur if the electrolyte is permeable to the reactant (methanol), i.e., some of the reactant introduced at a first electrode of the fuel cell may pass through the electrolyte to the second electrode, instead of reacting at the first electrode. Reactant crossover typically causes a decrease in both reactant utilization efficiency and fuel cell performance. Fuel cell performance is defined by the voltage vs. current polarization curve. The higher the voltage is at a given current density, the better the performance. Or, alternatively, the higher the current density is at a given voltage, the better the performance.

Fuel efficiency utilization losses arise from methanol transport away from the anode since some of the methanol that would otherwise participate in the oxidation reaction at the anode and supply electrons to do work through the external circuit, is lost. Methanol arriving at the cathode has a deleterious effect as to decrease the Oxygen concentration at the cathode to form CO₂. However, in the likely event of incomplete reaction, CO is formed which acts further to poison the cathode surface. Furthermore, it has been well documented that for cathode electrocatalysts of the prior art, methanol oxidation poisons the catalytic activity of the electrocatalysts at the cathode. See, for example, Chu et al., J. Electrochem. Soc., Vol.141,1770-1773 (July 1994); Kuver et al., Electrochemica Acta, Vol. 43, 2527-2535 (1998); Cruickshank et al., J. Power Sources, Vol. 70, 40-47 (1998); and Kuver et al., J. Power Sources, Vol. 74, 211-218 (1998). Several prior art patents have focused on reducing reactant crossover in electrochemical fuel cells, generally through modifications of the electrolyte membrane or the anode electrode itself. See, for example, U.S. Pat. Nos. 5,672,438; 5,672,439; 5,874,182; 5,849,428; 5,945,231; and 5,919,583. However, it has generally been found that electrolyte membranes that reduce methanol crossover also reduce fuel cell performance in that ion transfer is reduced. Essentially, a tradeoff is being made. Moreover, none of these prior art patents deal with improvements to the cathode electrocatalyst material itself in order to make the catalyst methanol tolerant.

The present invention provides novel electrocatalysts useful for oxygen reduction while at the same time being methanol “tolerant”. Being “tolerant” to methanol means that these new catalysts do not oxidize methanol and, subsequently, are not poisoned by methanol or any of its oxidation products such as CO. Methanol transported to the cathode does not participate in any chemical or electrochemical reaction. Moreover, these new catalysts have excellent oxygen reduction catalytic activity.

The state-of-the-art electrocatalysts used for the reduction of oxygen generally comprise platinum or platinum-metal alloys on a substrate of carbon powder or the like. See, for example, U.S. Pat. Nos. 4,316,944; 4,822,699; 4,264,685; and 5,876,867. In addition, metal-containing macrocyclic compounds have been investigated for a number of years as fuel cell catalysts. These metal macrocyclic compounds include N₄-chelate compounds, such as phthalocyanines, porphyrins, and tetraazaannulenes. See, for example, U.S. Pat. No. 5,316,990 and Faubert et al., Electrochemica Acta, Vol. 43, pp.341-353, (1998). However, these catalysts have not proven to be methanol tolerant.

The systems on the basis of MoRuX where X=S, Se or Te also were suggested (V. Trapp. P. Christensen, A. Hamnett, J. Chem. Soc., Trans., 92(1996)4311, R. W. Reeve, P. Christensen, A. Hamnett et al, J.Electrochem.Soc.,145(1998)3463). The long-term stability of such cathodes is very low. In addition, the preparation of such material by pure catalytic methods is very difficult due to low reproducibility of described procedures.

The present invention provides methanol tolerant electrocatalysts, and a method of making the same, fulfilling the needs of direct methanol fuel cells. These novel catalysts are excellent oxygen reduction materials while at the same time not causing methanol oxidation or being poisoned by the presence of methanol.

In the article, Methanol-resistant cathodic oxygen reduction catalyst for methanol fuel cells, H. Tributsch, M. Bron, M. Hilgendorff et al J. Appl. Electrochem. 31 (2001) 739-748); results are presented for MoRuX and RuSe systems. These catalysts are colloidal ruthenium carbonyl complexes.

### SUMMARY OF THE INVENTION

In a first aspect, the disclosure provides a novel family of methanol tolerant catalyst material obtained by mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating of the clusters adsorbed on the electrically conductive component at a temperature of at least 175° C. In one embodiment, the electrically conductive component is chosen from particulate carbons such as carbon black, conducting polymers, conducting transition metal carbides, conducting metal oxide bronzes and other conducting carbons. These catalyst materials show a definite composition, long-term stability and high catalytic oxygen reduction activity. It is believed that these nanostructured electrocatalysts have di-facial configurations wherein the metal chalcogenide cluster performs the role of catalyst and the chalcogenides may also act as bridges to transfer electrons to catalyze reduction of the oxygen molecule.

In a second aspect, the disclosure provides a methanol tolerant electrocatalyst material comprising a heat-treated chalcogenide adsorbed onto an electrically conductive component, the chalcogenide being from the group of MₙFeₚXₘ, MₙXₘ, MₙClₚXₘ, or mixtures thereof wherein M=Pt, Ru or Re, X=S, Se or Te, and m, n and p=1 or 2. The catalyst material comprises a di-facial nano-structured configuration.

The disclosure also provides a method for producing a catalyst material including the steps of (a) mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; (b) removing the solvent; and (c) in a non-oxidizing atmosphere, heat-treating the clusters adsorbed on the electrically conductive component at a temperature of at least 175° C.

### BRIEF DESCRIPTION OF THE DRAWINGS

FIG. 1 shows the chemical structure of the materials used for preparation of the electrocatalysts of the present invention.

FIG. 2A is a schematic representation of the electrocatalyst of the present invention interacting with an oxygen molecule.

FIG. 2B is a schematic representation of a proposed mechanism for catalytic oxygen reduction by the electrocatalysts of the present invention.

FIG. 3 is a graph showing the oxygen reduction characteristics for a platinum-black gas-diffusion electrode with and without the presence of methanol.

FIG. 4 is a graph comparing the oxygen reduction characteristics of Pt-black catalyst and a heat-treated PtFeX catalyst, where X=S, Se, or Te (Examples 1, 2, 3 of the present invention).

FIGS. 5A and 5B are graphs comparing the oxygen reduction characteristics of Pt-black catalyst and heat-treated PtFeX catalysts, where X=S, or Te (Example 1, 3 of the present invention) all in the presence of methanol on gas-diffusion electrodes.

FIG. 6 is a graph showing the prolonged tests for oxygen reduction at various heat-treated PtFeX catalysts on carbon black gas-diffusion electrodes in 5N H2SO4 at 80° C. in the presence of 2M CH3OH.

FIG. 7 is a graph comparing the oxygen reduction characteristics of Pt-black catalyst and heat-treated Pt X catalysts where X=S, or Te (Example 6, 7 of the present invention).

FIG. 8 is a graph comparing the oxygen reduction characteristics of Pt-black catalyst, and heat-treated PtX catalysts, where X=S, or Te, (Example 6, 7 of the present invention) in the presence of 2M methanol on gas-diffusion electrodes.

FIG. 9 is a cyclic voltamagraph of Pt—Fe—S with catalyst loading of 1.7 mg/cm2. Scan rates vary from 10-50 mV/sec.

FIG. 10 is a cyclic voltamagraph of Pt—Fe—Se with catalyst loading of 1.0 mg/ cm2. Scan rates vary from 1-100 mV/sec.

FIG. 11 is a cyclic voltamagraph of Pt—Fe—Te with catalyst loading of 2.0-mg/cm2. Scan rates vary from 1-50 mV/sec.

FIG. 12 is a cyclic volatmagraph of Pt—Fe—S. Comparison is made before and after storage in an electrolyte for 1 hour.

FIG. 13 is a cyclic volatmagraph of Pt—Fe—Se. Comparison is made before and after storage in an electrolyte for 2 hour.

FIG. 14. is a cyclic volatmagraph of Pt—Fe—Te. Comparison is made before and after storage in an electrolyte for 2 and 8 hours

FIG. 15 is an SEM for a freshly prepared Pt—Fe—S catalyst electrode.

FIG. 16 is an SEM for a Pt—Fe—S catalyst electrode after cyclic voltamagraphs were taken.

FIG. 17 is a comparison of oxygen reduction polarization curves for Pt—Fe—S, Re—Fe—S, and Ru—Fe—S catalysts in oxygen saturated sulfuric acid solution. Catalyst loadings are between 1.0-1.5 mg/cm2.

FIG. 18 is a comparison of oxygen reduction polarization curves for Mo—Ru—S, Re—Fe2—S2, and Ru—Fe2-S2, catalysts in oxygen saturated sulfuric acid solution. Catalyst loadings are between 1.2-1.6 mg/cm2.

### DETAILED DESCRIPTION OF THE INVENTION

Catalyst:

The catalysts of the present invention are compositions of matter having a structure including catalytic active sites. These active sites may consist of at least two different kinds of metal atoms MFeX or MX where M=Pt, Ru, or Re, and X=S, Se, or Te. The catalytic compounds containing these active sites are distributed on or in conductive carbon, graphite nanostructures, or other suitable electrically conductive substrates or supports, hereafter referred to as an electrically conductive component. These new catalyst materials are very effective at catalyzing 4-electron oxygen reduction to water, while being completely inactive towards the oxidation of methanol.

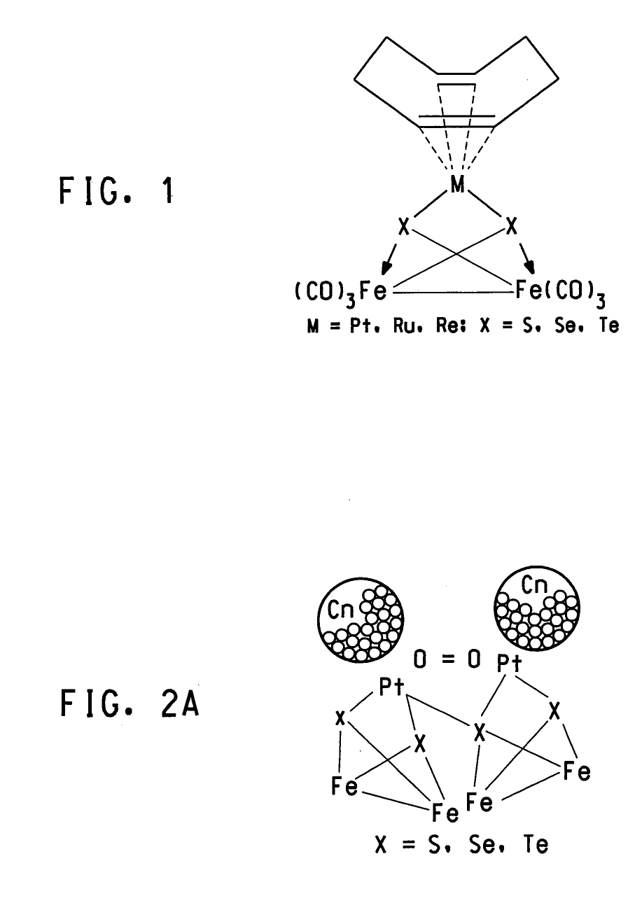

In one embodiment, the methanol tolerant catalyst material is obtained by mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating the clusters adsorbed on the electrically conductive component at a temperature of at least 175° C. An example of the chemical structure of a starting material is shown in FIG. 1, where a metal-containing compound where M represents a precious metal selected from Pt, Ru and Re.

The catalyst material is produced by mixing together (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component. The electrically conductive component preferably is chosen from particulate carbons such as carbon black, conducting polymers, conducting transition metal carbides, conducting metal oxide bronzes and other conducting carbons. According to a preferred embodiment, the electrically conductive component is a carbon support such as a particulate carbon or a carbon paper. Examples of suitable conducting carbons include turbostratic carbon and graphitic carbon. Any organic solvent is suitable provided that the solvent is inert to all reactants used and products formed, and mixtures of such solvents may also be utilized. One such suitable solvent is THF.

After the organometallic clusters have adsorbed on the electrically conductive component, the solvent is then removed so as to leave behind the electrically conducting component with the organometallic clusters adsorbed thereto. The solvent may be removed by vacuum drying or by other solvent removal methods know in the art.

The term “electrically conductive component” as used herein can include particulate carbons, conducting polymers such as polyaniline or polypyrrole, conducting transition metal carbides, conducting metal oxide bronzes and other conducting carbons. Preferred carbons are turbostratic or graphitic carbons of varying surface areas such as Vulcan® XC72R (available from Cabot Corp., Alpharetta, Ga.), Ketjen black® EC-600JD or EC-300J (available from Akzo Nobel Inc., Chicago, Ill.), Black Pearls® (available from Cabot Corp.), acetylene black (available as Denka® Black from Denki Kagku Kogyo Kabushiki Kaisha, Tokyo, Japan), as well as other conducting carbon varieties. Other carbons include carbon fibers, single- or multi-wall carbon nanotubes, and other carbon structures (e.g., fullerenes and nanohorns). Typically, electrically conductive components include Vulcan® XC72R and Ketjenblack® EC-600JD.

In a non-oxidizing atmosphere such as an inert gas, the clusters adsorbed onto the electrically conducting support are heat-treated by heating them to a temperature of at least 175° C. It has been found that thermolysis of the clusters begins at a temperature about 100° C. and then, at a temperature about 140° C. the elimination of cyclic hydrocarbon ligands, namely dicyclopentadiene or cyclooctadiene takes place. Finally, at a temperature 175° C., most of CO ligands are lost. When the electrically conductive component is in the form of a particulated carbon powder, the powders are heat-treated at about 200-250° C. for removing the ligands. Typically, the heat-treatment is carried out for at an hour, and preferably about 2 hours, under a protected non-oxidizing gas atmosphere of nitrogen or argon.

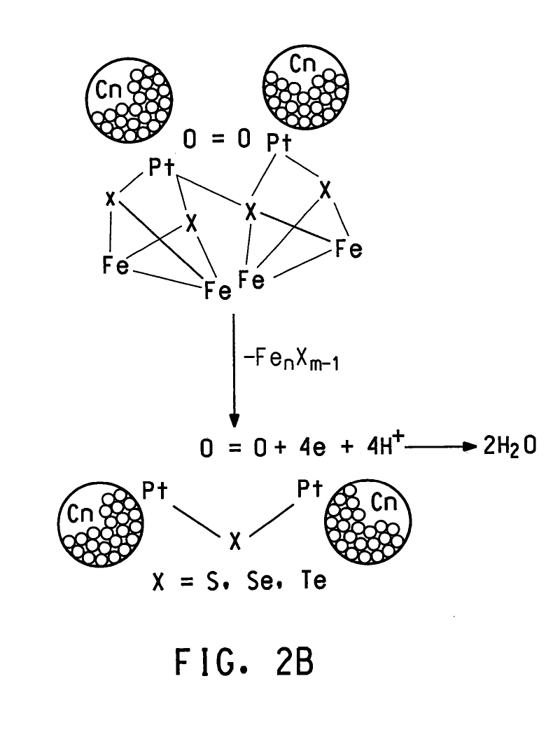

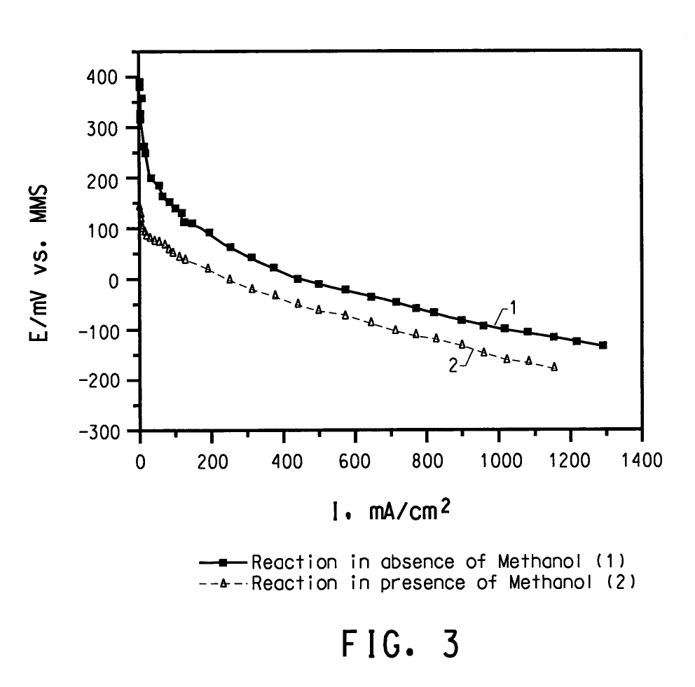

It is believed that after heat-treatment a di-facial nano-structured electrocatalyst is formed where both of the different metals M are capable of interacting with oxygen molecules to catalyze oxygen reduction, as shown in FIG. 2A. A mechanism for this catalytic oxygen reduction has been proposed, and is shown in FIG. 2B. In FIGS. 2A and 2B, Cn represents the electrically conductive component such as a carbon support. Where the electrically conductive component is particulate carbon, the catalyst material preferably comprises 10-30 wt % of the chalcogen containing group such as MₙFeₚXₘ or MₙXₘ and 70-90 wt % of particulate carbon

The electronic conductivity of the catalysts is improved by the addition of inert conductive materials such as carbon or graphite and the heat treatment at a temperature of at least 175° C. The catalytic activity of various catalyst materials was evaluated by electrochemical measurements, including cyclic voltammetry (CV) on gas-diffusion electrodes.

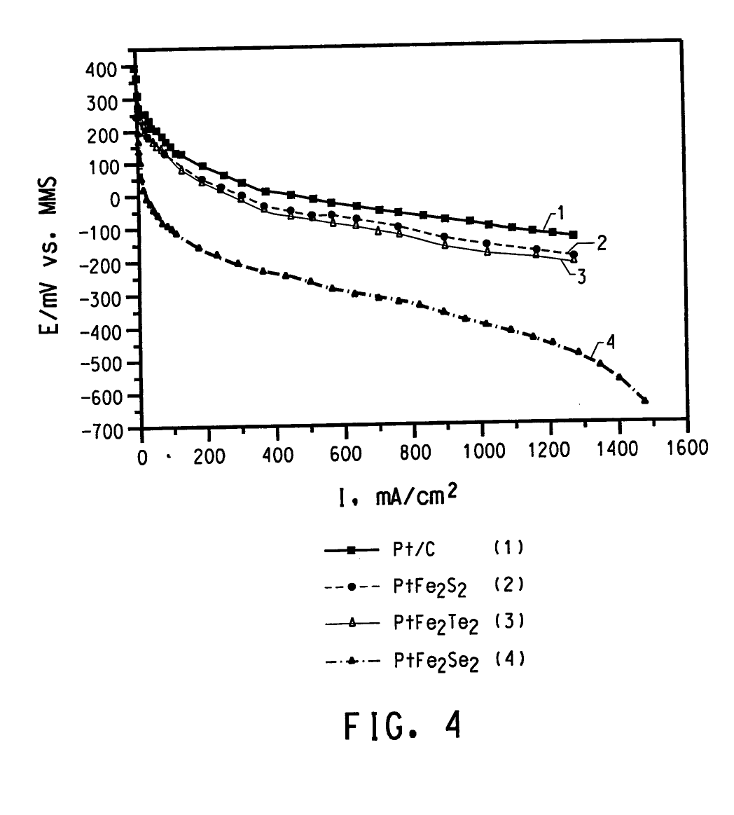

FIG. 3 shows the current-potential curves for a platinum-black gas-diffusion electrode of the prior art with and without methanol present. The electrolyte was oxygen saturated 2.5 M H₂SO₄ with and without 2.0 molar methanol. Here, the reduction current is defined as positive, and the oxidation current is defined as negative. It is clear from FIG. 3 that the Pt-black electrode (carbon substrate with Pt catalyst) shows significantly less oxygen reduction in the presence of methanol than without methanol present. Of course, with methanol present the Pt-black electrode is catalytically active for both oxygen reduction and methanol oxidation, therefore, this causes significant methanol oxidation and decreases the catalytic activity for oxygen reduction. This figure illustrates the behavior of platinum with and without the presence of methanol.

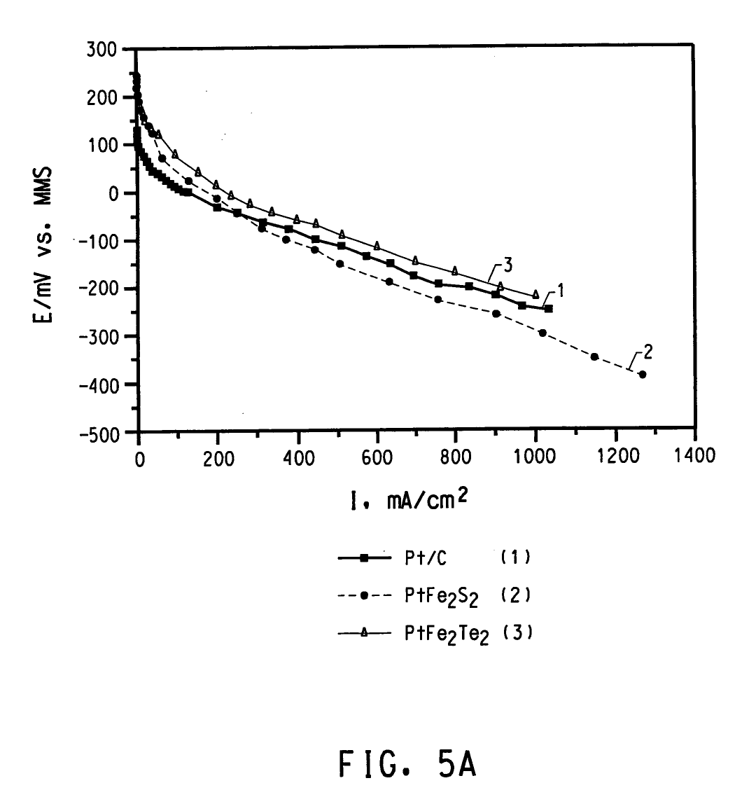

FIG. 4 shows the current-potential curves oxygen reduction for PtFeX where X=S, Se, Te carbon supported gas-diffusion electrodes in 2.5 M H₂SO₄ in the absence of methanol.

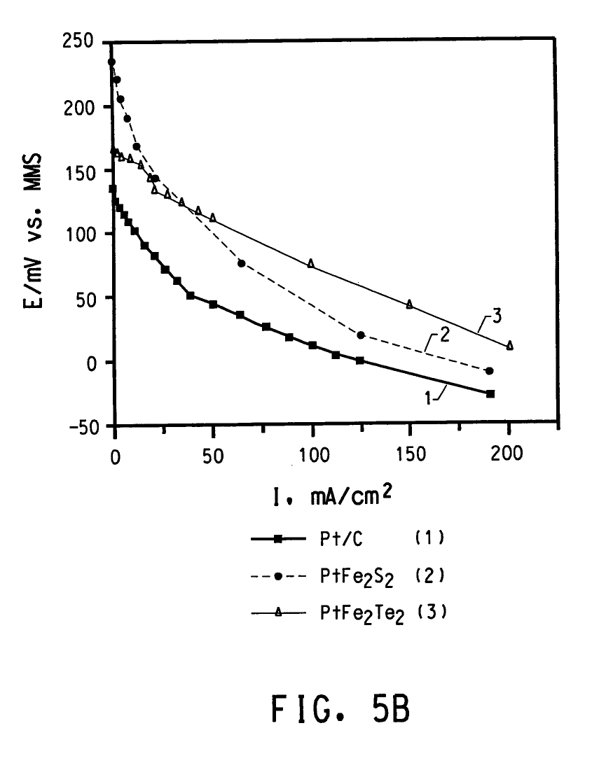

FIG. 5 shows the current-potential curves for PtFeX where X=S, Se, Te carbon supported gas-diffusion electrodes in 5 M H₂SO₄ in the presence of 2 M CH₃OH.

In summary PtFeX and PtX systems have catalytic activity superior to Pt-black for oxygen reduction in the presence of methanol, and shows no catalytic activity towards methanol electrooxidation. Thus, the electrocatalysts of the present invention are clearly methanol tolerant, i.e., they don't interact with methanol nor are they poisoned by its presence.

The present invention will now be described below in greater detail 10 by way of Examples, which serve to illustrate the preparation and testing of illustrative embodiments of the present invention.

### EXAMPLES

TABLE 1
Summary of Syntheses of mixed-metal chalcogenides MFeX and homometallic
MX clusters, where M = Pt, Ru, or Re; X = S, Se, Te.

| PRODUCT SYNTHESIZED | REACTANT | REACTANT | SOLVENT |
|---|---|---|---|
| (CO)₆Fe₂S₂Pt(C₁₀H₁₂) (1) | Fe₃S₂(CO)₉ | (C₁₀H₁₂)PtCl₂ | THF |
| (CO)₆Fe₂Se₂Pt(C₁₀H₁₂) (2) | Fe₃Se₂(CO)₉ | (C₁₀H₁₂)PtCl₂ | THF |
| (π-Cyclooctadiene)platinum- | Fe₃Se₂(CO)₉ | (C₈H₁₂)PtCl₂ | THF |
| bis(tricarbonyliron-μ₃-sulfide)[Fe—Fe], | | | |
| (COD)Pt(μ₃-S)₂Fe₂(CO)₆ (3) | | | |
| (π-Cyclooctadiene)platinum- | Fe₃Te₂(CO)₉ | (C₈H₁₂)PtCl₂ | THF |
| bis(tricarbonyliron-μ₃-telluride)[Fe—Fe], | | | |
| (COD)Pt(μ₃-Te)₂Fe₂(CO)_{6 (5)} and | | | |
| tetracarbonyldiplatinum ditelluride, | | | |
| (CO)₄Pt₂Te₂ (6). | | | |
| (C₈H₁₂PtCl)₂S (7) | Na(S^{t}Bu) | (C₈H₁₂)PtCl₂ | THF |
| (C₁₀H₁₂PtCl)₂Te (8) | NaPhTe | (C₁₀H₁₂)PtCl₂ | THF |
| Fe₂RuS₂(CO)₉ (9) | Ru₃(CO)₁₂ | Ru(CO)₄(C₂H₄) | Hexane |
| Fe₂RuSe₂(CO)₉(10) | Ru(CO)₄(C₂H₄) | Fe₂Se₂(CO)₆ | Hexane |
| Cp′Re(μ-CO)S₂Fe₂(CO)₆ (11) | Cp′Re(CO)₃ | Fe₂S₂(CO)₆ | THF |

Representative Synthetic Method:
1. Synthesis of (CO)₆Fe₂S₂Pt(C₁₀H₁₂) (1)

(Dicyclopentadiene)platinum-bis(tricarbonyliron-chalcogenide)s were prepared according to the following procedure: 0.15 g (0.31 mmol) of Fe₃S₂(CO)₉ was added to a colorless solution of 0.25 g (0.62 mmol) (C_{10H}₁₂)PtCl₂ in 40 ml of THF and the mixture was refluxed for 9 hours. The resulting dark-red solution was filtered and evaporated in vacuum. The solid residue was extracted with 25 ml of diethyl ether. The solution was then concentrated to ¼ of initial volume and after addition of 6 ml of hexane was kept at −18° C. for 48 hours. The red crystalline precipitate was separated, washed with hexane and dried in vacuum. Yield was 0.11 g (55%).

Found (%): C, 29.16, H 1.87, S 9.97. C₁₆H₁₂S₂O₆Fe₂Pt. Calculated (%): C 28.63, H 1.80, S 9.55.

IR-spectra (KBr,ν,cm⁻¹):550 s.,570 m.,610 m.,790 w., 1930 s., 1950 s, 1975 s, 1985 s, 2005 s., 2052 s.

The monocrystals for X-Ray analysis were obtained in CH₂Cl₂-hexane mixture. By the differential scanning calorimetry the quantitative elimination of the next fragments was demonstrated:

| | C₁₀H₁₂ | 4 CO |
|---|---|---|
| Found (%) | 20.0 | 16.0 |
| Calculated (%) | 19.7 | 16.7 |

The brutto composition of the thermo destruction product was Fe₂PtS₂C₂O₂.
Electrochemical Evaluation:

A conventional three-compartment electrochemical cell, in which reference, counter, and working electrodes were separated, was used for evaluation of the prepared catalysts. A mercury/mercury sulfate (MMS) electrode was used as the reference electrode. Platinum wire was used as the counter electrode. The prepared catalyst powder was affixed to Teflon® coated carbon paper' carbon paper as the working gas-diffusion electrode. Electrolytes were prepared from twice distilled water and high purity sulfuric acid with different concentrations of methanol. High purity argon was used for de-aeration of solution. EG&G PAR 273 potentiostat was used for electrochemical measurements.

Preparation of Gas-diffusion Electrodes:

The preparation of test electrodes, for the evaluation of catalyst performance, consists of two main stages: (i) preparation of gas-diffusion base (diffusion layer) with current collector, (ii) application of catalyst, i.e. forming of active layer.

Preparation of Gas-diffusion Base:

EC-TP2-060 Torey® carbon paper (untreated) with a thickness of 0.2 mm was used. Discs with diameter of 13 mm cut out this paper were impregnated by the water suspension of polytetrafluoroethylene. The amount of this hydrophobic agent was about 20-wt % (accounted for dry substances); this value corresponds to 1.8 mg/cm² of the paper. Impregnated samples were dried and heat-treated at the temperature of 340 ° C. for 10 min.

Hydrophobic properties of the samples were tested with concentrated sulfuric acid. Small drops of the acid were placed onto surface of the samples. If such drops were not absorbed in the base within a day, the base was considered to be hydrophobic enough.

A special current collector was not attached to this base. Instead of that a current collector in an electrochemical cell was used.

Forming of the Active Layer:

A slurry for the application of the catalyst layer was made from the catalyst powder (heat-treated catalysts N (1-12) on carbon black) and water PTFE suspension. To do this the initially concentrated PTFE suspension purchased from Moscow Energy Institute, Russia, (ca. 55%) was diluted with water 1:100. In the most cases the slurry contained 20% dry PTFE based on the weight of the catalyst. The slurry was stabilized by ultrasonic irradiation for 10 min. Immediately after the ultrasonic treatment, the slurry was dried in the drying box at 100° C. up to constant weight. Calculated amount (usually, 1-2 mg/cm²) of the dry mass was applied using a doctor blade onto front surface of the gas-diffusion base. Afterwards the electrodes were pressed with a pressure of 5 MPa for 1 min., and then they were heat-treated at 320-340 ° C. for 10 min. All electrodes had a disc shape with diameter of 13 mm; active mass being deposited in the central part and having an area of 1 cm². Preparation of the supported electrocatalysts and their electrochemical performances are disclosed in the following examples:

### Example 1

The powder of Ketjen® black (66 mg) was soaked under Ar with solutions of aforedescribed cluster (CO)₆Fe₂S₂Pt(C₁₀H₁₂) (1) ( 47 mg) in 10 ml of tetrahydrofuran and dried in vacuum. The quantity of the cluster was calculated to obtain active supported catalyst with correlation catalyst: support of 1:2. After that the powder was heated in an Ar stream at 200° C. for 2 hours and cooled in Ar atmosphere. In the separate experiments by the differential scanning calorimetry (DSC) were shown that thermolysis of the clusters begins at a temperature about 100° C. and then, at a temperature about 140° C. the elimination of cyclic hydrocarbon ligands, namely dicyclopentadiene or cyclooctadiene takes place. Finally, at a temperature 175° C., most of CO ligands are lost. The final product of thermolyses had the composition Fe₂PtS₂C₂O₂.

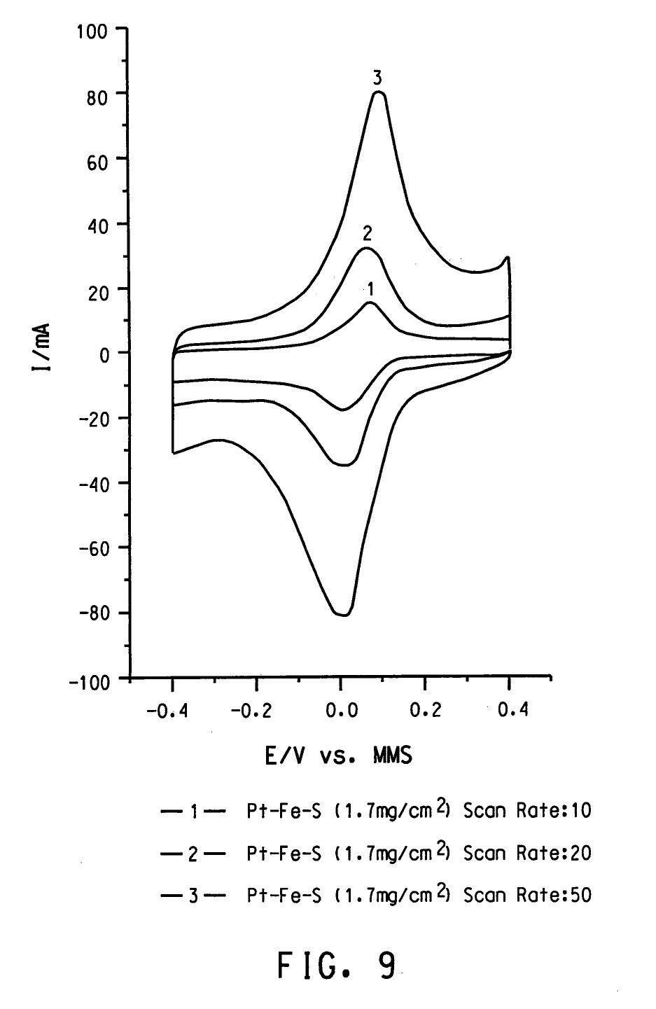

The redox behavior of catalyst based on (1) is presented in FIG. 9. FIG. 9 shows a cyclic voltamagraph (CV) recorded at the electrode with freshly prepared Pt—Fe—S catalyst. The CV was recorded in 5 M H₂SO₄. The CV has a shape typical to reversible redox processes. A couple of similar peaks; the peak potentials are independent on scan rate; the difference between peak potentials equal to 60 mV; the peak currents are proportional to square root from scan rate; all these facts bear testimony to a rather high reversibility degree of the electrode processes. One can suppose that these processes are connected with valency altering of iron atoms in the catalyst's unit.

The catalytic activity of the catalyst based on (1) was evaluated on a gas-diffusion electrode in oxygen saturated 2.5 M H₂SO₄ solution in the absence and in the presence of 2.0 molar methanol. When compared to platinum black, the present catalyst had a superior catalytic activity for oxygen reduction in the presence of 2.0 molar methanol. These results are presented as Example 1 in FIG. 5.

### Example 2

The powder of Ketjen® black (66 mg) was soaked under Ar with solutions of aforedescribed (CO)₆Fe₂Se₂Pt(C₁₀H₁₂) (2) (48.5 mg) in 10 ml of tetrahydrofuran and dried in vacuum. The quantity of cluster was calculated to obtain active supported catalyst with correlation catalyst: support as 1:2. After that the powder was heated in an Ar stream at 200° C. for 2 hours and cooled in Ar atmosphere. The final product of thermolyses had the composition Fe₂PtSe₂C₂O₂.

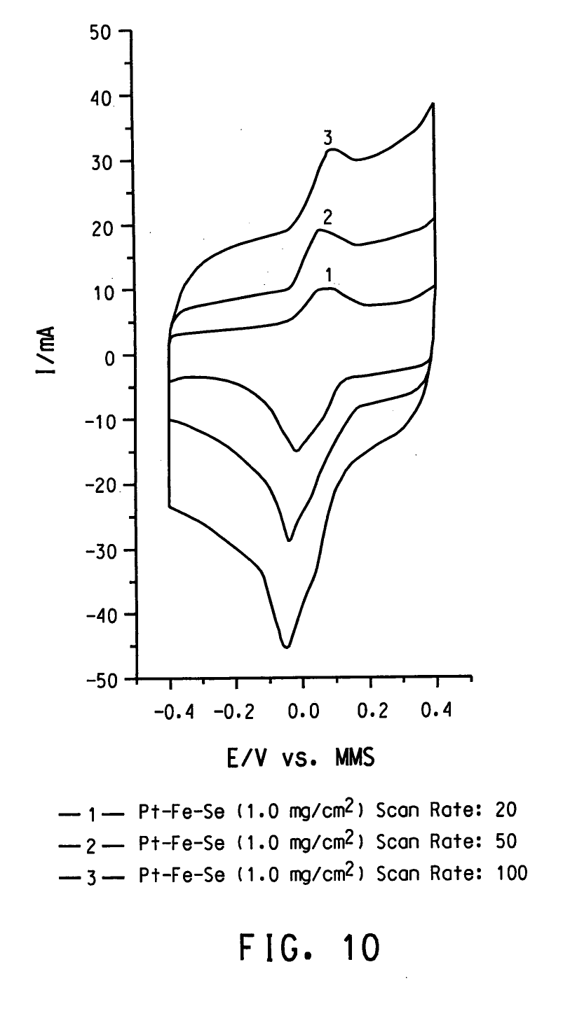

The redox behavior of catalyst based on (2) is presented in FIG. 10. FIG. 10 shows the CV recorded at the electrode with freshly prepared Pt—Fe—Se catalyst and the CV was recorded in 2.5 M H₂SO₄. One can note some decrease in the degree of reversibility of the redox process in comparison with the catalyst based on (1). However, the nature of the process is the same and ascribed to the valency altering of iron atoms.

The catalytic activity of this catalyst was evaluated on a gas-diffusion electrode in oxygen saturated 2.5 M H₂SO₄ solution. These experimental results are presented as Example 2 in FIG. 4.

### Example 3

The powder of Ketjen® black (66 mg) was soaked under Ar with solutions of aforedescribed cluster (COD)Pt(μ₃-Te)₂Fe₂(CO)₆ (5) ( 44.7 mg) in 10 ml of tetrahydrofuran and dried in vacuum. The quantity of cluster was calculated to obtain supported catalyst with correlation catalyst: support as 1:2. After that the powder was heated in an Ar stream at 200° C. for 2 hours and cooled in Ar atmosphere. The final product of thermolyses had the composition Fe₂PtTe₂C₂O₂.

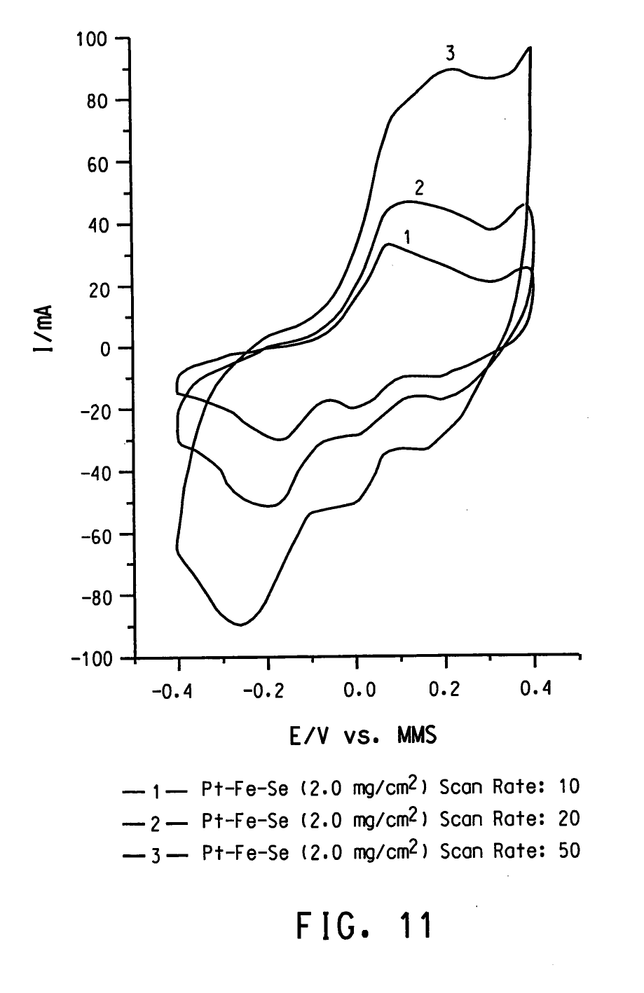

The redox behavior of catalyst based on (5) presented in FIG. 11 shows CV for freshly prepared electrode with Pt—Fe—Te catalyst. This CV is typical for irreversible processes. One anodic but three cathodic peaks can be seen at the CV with rather high difference between potential of anodic and corresponding cathodic peaks.

Examination of FIGS. 9-11 reveals a good correlation between redox behavior of diene-bis(tricarbonyl) clusters of Pt—Fe-chalcogenides (CVs on glassy carbon electrode in CH₂Cl₂ with Bu₄NPF₆ are not presented here) and that of corresponding supported catalysts. From the point of view of reversibility the catalysts under study can be arranged in the same row as the clusters: Pt—Fe—S>Pt—Fe—Se>>Pt—Fe—Te.

The catalytic activity of the catalyst based on (5) was evaluated on a gas-diffusion electrode in oxygen saturated 2.5 M H₂SO₄ solution in the absence and in the presence of 2.0 molar methanol. These experimental results are presented as Example 3 in FIG. 4 and FIG. 5.

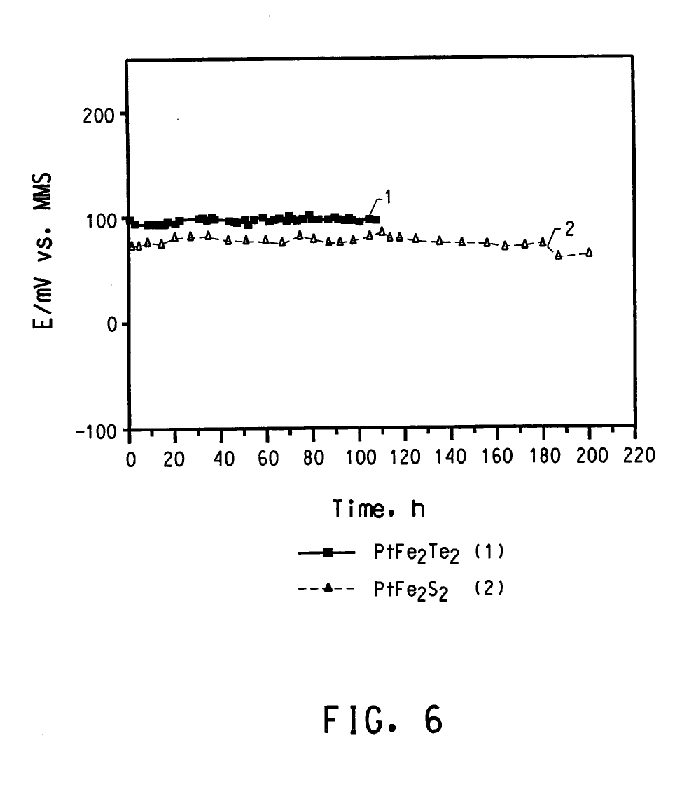

The results of prolonged tests of the electrodes with PtFe₂Te₂ (1.9 mg/cm²) (1) and PtFe₂S₂—catalysts (1.7 mg/cm²) (2) at 800° C. in 2.5 M H₂SO₄ with 2 M CH₃OH (50 mA/cm²) show a good long-term stability as presented in FIG. 6.

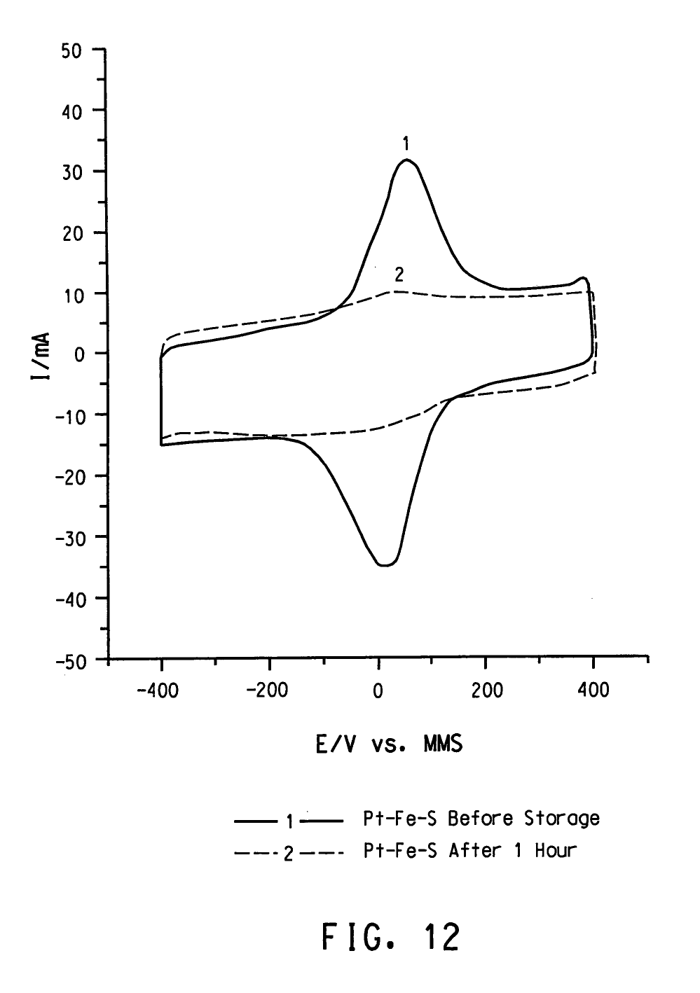

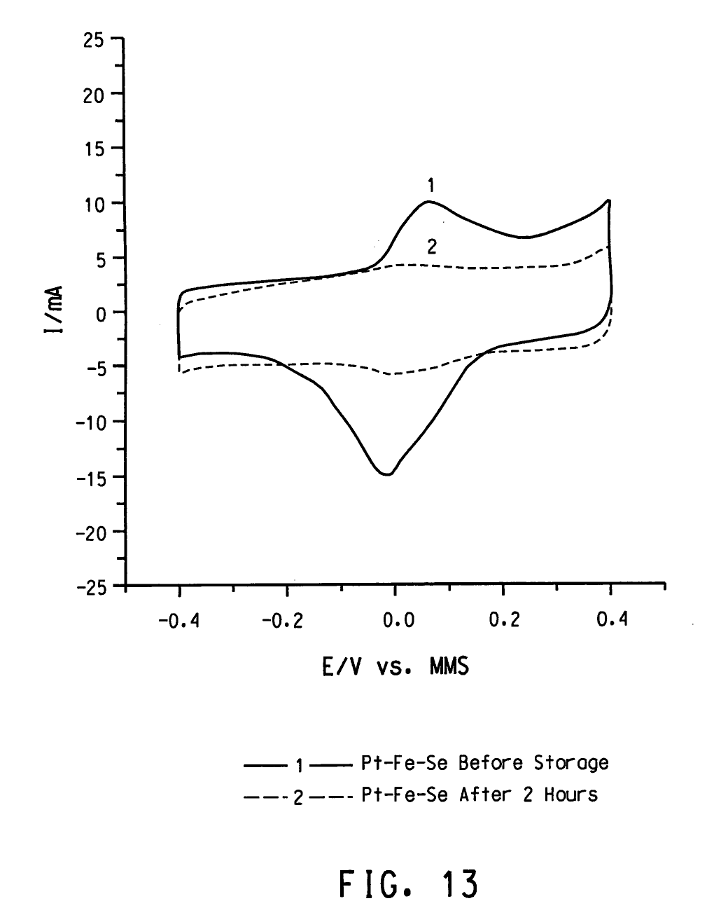

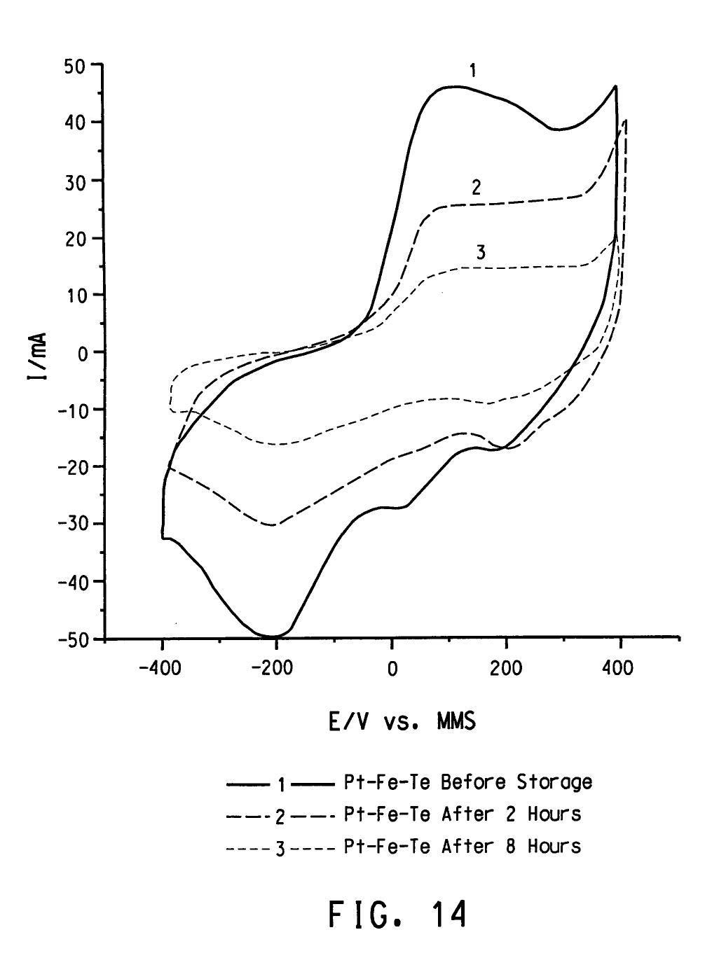

Recall once more that CV shown in FIGS. 9-11 refers to freshly prepared electrodes. Even short-term storage of the electrodes in water acid electrolyte or their short-term electrochemical treatment (e.g. registering CV) results in a drastic change of CV. These changes were different for Pt—Fe—S and Pt—Fe—Se catalysts on the one hand, and for Pt—Fe—Te catalyst on the other hand. In the former two cases the changes consist of disappearance of redox-peaks connected with iron atoms. FIGS. 12 and 13 show CV for electrodes with Pt—Fe—S and Pt—Fe—Se catalysts before and after storage. In the case of an electrode with Pt—Fe—Te catalyst its storage in an electrolyte resulted in decrease of redox peaks without altering of their shape, see FIG. 14.

Such behavior of CV can be the result of iron disappearance from the surface layers of the catalysts. This process occurs rather fast in the Pt—Fe—S and Pt—Fe—Se catalysts and much slower in the Pt—Fe—Te catalyst.

EDAX Investigation of PtFeS Catalysts

To check the suggestion that iron leaches from the supported Pt—Fe—S catalyst, EDAX, Energy Dispersive Analysis by X-ray, experiments were carried out. A comparison was made between a freshly prepared electrode and one that has undergone voltammetric studies. The results of the analysis confirm that iron leaches from the supported Pt—Fe—S catalyst samples. The surface composition of the freshly prepared sample had the following atomic percentages (%): Pt 14.23, Fe 39.66, S 43.01, Cl 2.16, Si 0.95. EDAX errors are ascribed to the presence of Cl and Si. Nominal atomic composition of PtFe₂S₂ is Pt 20, Fe 40, S 40; whereas, the real surface composition is Pt 0.71 Fe 1.98 S 2.15. EDAX results for the sample involving the voltammetry experiments, revealed only 2.72 atomic % iron, and in other similar samples no iron was seen.

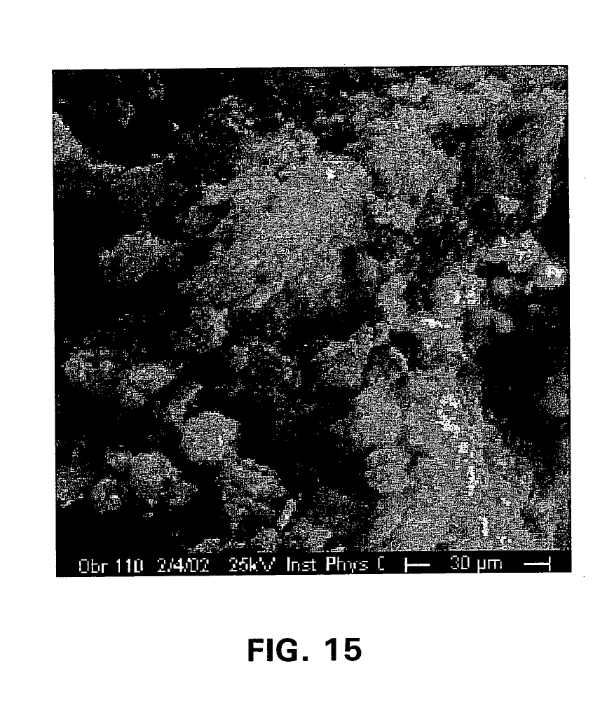

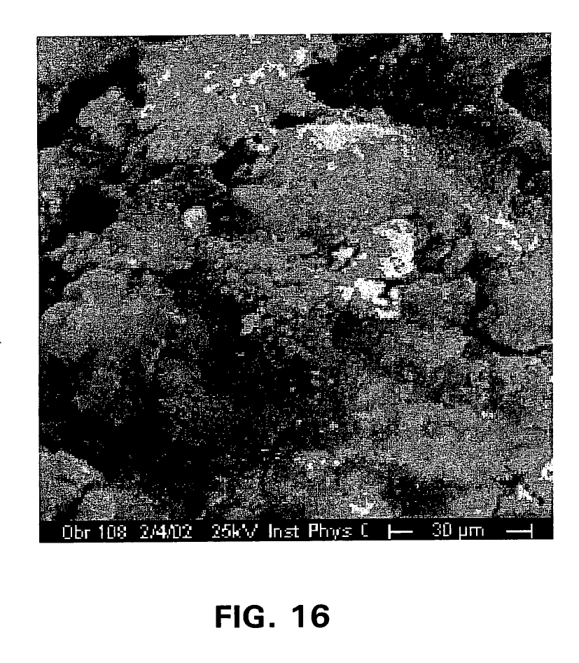

The scanning electron microphotography (SEM) obtained simultaneously with the EDAX confirmed a rather uniform distribution of the catalysts over the electrode surface. Such SEMs for the sample #s 110, 108, are shown in FIGS. 15 and 16.

### Example 4

The powder of Ketjen® black (66 mg) was soaked under Ar with solutions of the afore-described cluster Cp′Re(μ-CO)S₂Fe₂(CO)₆ (11) (50.0 mg) in 10 ml of CH₂Cl₂ and dried in vacuum. The quantity of cluster was calculated to obtain supported catalyst with correlation catalyst: support as 1:2. The powder was then heated in an Ar stream at 200° C. for 2 hours and cooled in Ar atmosphere. The final product of thermolyses had the composition Fe₂ReS₂C₂O₂.

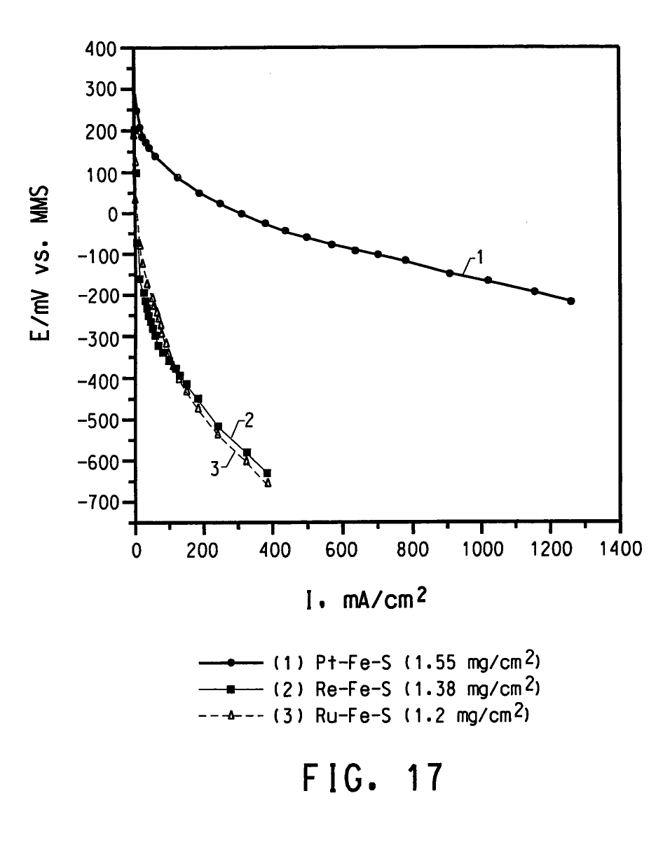

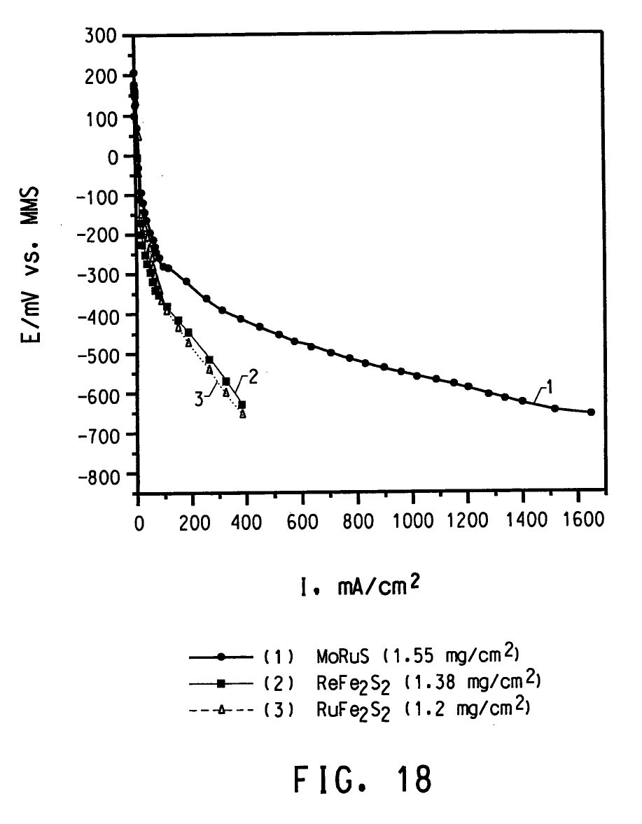

The catalytic activity of this catalyst was evaluated on a gas-diffusion electrode in oxygen saturated 2.5 M H₂SO₄ solution. These experimental results are presented as Example 4 in comparison with Pt—Fe—S and MoRuS catalysts in FIGS. 17 and 18.

### Example 5

The powder of Ketjen® black (66 mg) was soaked under Ar with solutions of the afore-described Fe₂RuS₂(CO)₉ (9) (58.5 mg) in 10 ml of CH₂Cl₂ and dried in vacuum. The quantity of cluster was calculated to obtain supported catalyst with correlation catalyst:support as 1:2. The powder was then heated in an Ar stream at 200° C. for 2 hours and cooled in Ar atmosphere. The final product of thermolyses had the composition Fe₂RuS₂C₂O₂.

The redox behavior of catalyst based on (9) and (11) was similar to the freshly prepared Pt—Fe—Se catalyst (FIG. 10). In all cases, fully reversible redox peaks at the same potential range could not be seen. Even though a similarity in catalytic activity for these catalysts was expected, this was not found. FIG. 17 shows polarization curves for the oxygen reduction at the electrodes with Re—Fe—S and Ru—Fe—S catalysts in comparison with that for the electrode with Pt—Fe—S system. It is clear that electrocatalytical activity of the platinum-free catalysts is absolutely non-comparable with that of Pt—Fe—S catalyst. Moreover, the electrocatalytical activity of Re—Fe—S and Ru—Fe—S catalysts is inferior even to that of Mo—Ru—S catalyst (FIG. 18).

### Example 6

The powder of Ketjen® black (66 mg) was soaked under Ar with solutions of the afore-described cluster (C₁₀H₁₂PtCl)₂Te (8) (54.5 mg) in 10 ml of CH₂Cl₂ and dried in vacuum. The quantity of the cluster was calculated to obtain supported catalyst with correlation catalyst: support as 1:2. The powder was then heated in the Ar stream at 200° C. for 2 hours and cooled in Ar atmosphere. The final product of thermolyses had the composition Pt₂Te.

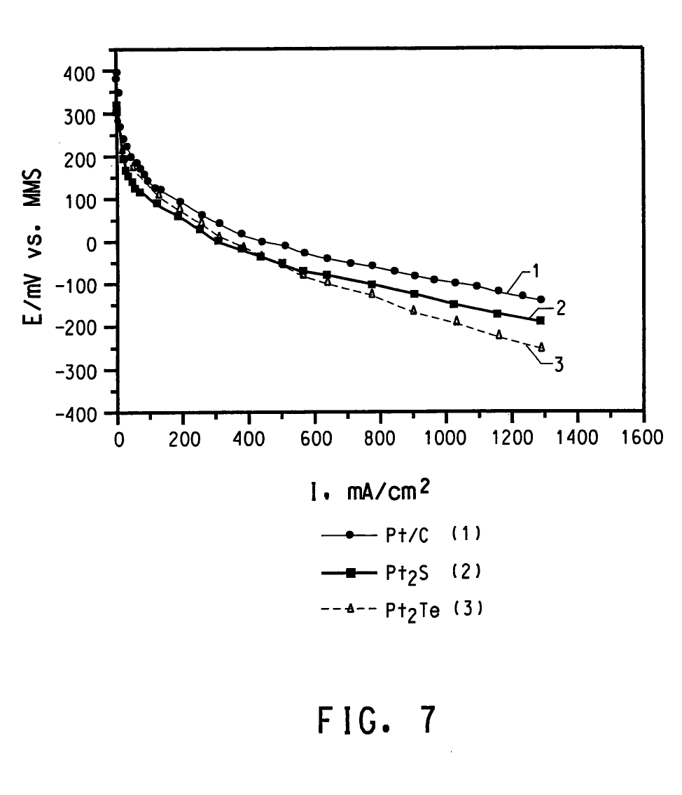

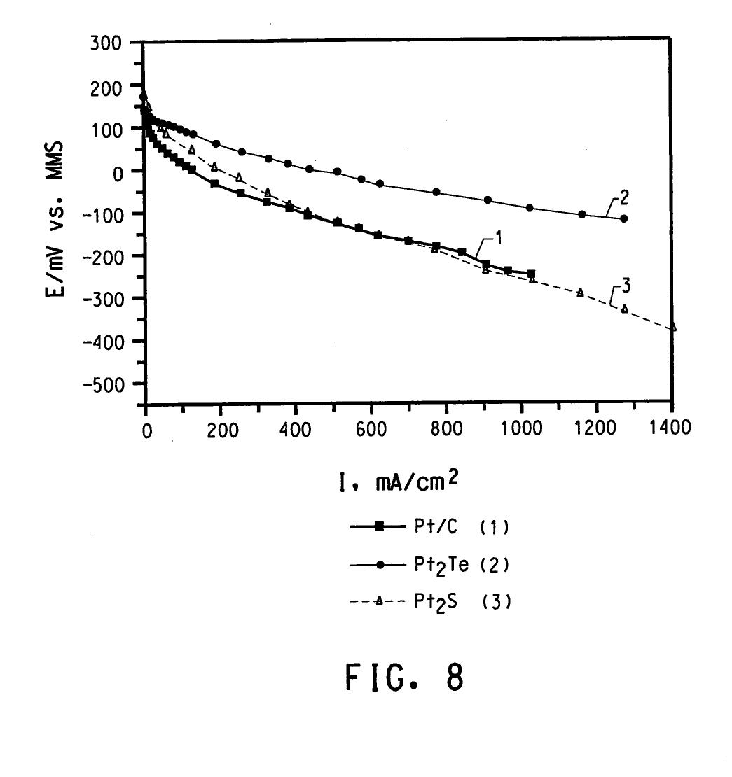

It was established that this electrocatalyst possesses rather high performance. A batch of new electrodes with the catalyst was manufactured and tested. FIGS. 7-8 show galvanostatic polarization curves for different electrodes. One can see that electrodes based on supported Pt₂Te have high performance, low sensitivity to poisoning action of methanol, and high reproducibility.

Prolonged test consisting of a galvanostatic intermittent load 6-8 hours per day with current density 50 mA/cm² at room temperature (ca. 22 ° C.) shows a good long-term stability of such electrodes.

### Example 7

The powder of Ketjen® black (66 mg) was soaked under Ar with solutions of the afore-described cluster (C₈H₁₂PtCl)₂S (7) (55.5 mg) in 10 ml of CH₂Cl₂ and dried in vacuum. The quantity of cluster was calculated to obtain supported catalyst with correlation catalyst: support as 1:2. After that the powder was heated in an Ar stream at 200° C. for 2 hours and cooled in Ar atmosphere. The final product of thermolyses had the composition PtS.

FIGS. 7-8 show galvanostatic polarization curves for PtS electrodes in comparison with Pt supported electrodes in the absence and in the presence of 2 M CH₃OH.

### Example 8

The powder of Ketjen® black (66 mg) was soaked under Ar with solutions of the afore-described cluster (CO)₄Pt₂Te₂ (6) (39.0 mg) in 20 ml of CH₂Cl₂ and dried in vacuum. The quantity of cluster was calculated to obtain supported catalyst with correlation catalyst: support as 1:2. The powder was then heated in an Ar stream at 200° C. for 2 hours and cooled in Ar atmosphere. The final product of thermolysis had the composition PtTe.

What is claimed is:

1. A catalyst material comprising the product obtained by
(a) mixing together:
(1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2,
(2) an electrically conductive component, and
(3) an organic solvent, such that the clusters are adsorbed on the electrically conductive component;
(b) subsequently removing the solvent; and
(c) in a non-oxidizing atmosphere, heat-treating of the clusters adsorbed on the electrically conductive component at a temperature of at least 175° C.

2. The catalyst material of claim 1, wherein the electrically conductive component is chosen from particulate carbons, conducting polymers, conducting transition metal carbides, conducting metal oxide bronzes and other conducting carbons.

3. The catalyst material of claim 1, wherein the electrically conductive component is a carbon support.

4. The catalyst material of claim 3, wherein the carbon support is particulate carbon.

5. The catalyst material of claim 3, wherein the electrically conductive component is a turbostratic or graphitic carbon.

6. The catalyst material of claim 1, wherein the clusters adsorbed on the electrically conductive component are heat-treated at about 200-250° C. for about 1-2 hours.

7. The catalyst material of claim 4, wherein the chalcogen containing group is MₙFeₚXₘ where M=Pt and X=S.

8. The catalyst material of claim 4, wherein the chalcogen containing group is MₙFeₚXₘ where M=Pt and X=Se.

9. The catalyst material of claim 4, wherein the chalcogen containing group is MₙFeₚXₘ where M=Pt and X=Te.

10. The catalyst material of claim 4, wherein the chalcogen containing group is MₙFeₚXₘ where M=Ru and X=S.

11. The catalyst material of claim 4, wherein the chalcogen containing group is MₙFeₚXₘ where M=Re and X=S.

12. The catalyst material of claim 4, wherein the chalcogen containing group is MₙFeₚXₘ and the catalyst material comprises 10-30 wt % of MₙFeₚXₘand 70-90 wt % of particulate carbon.

13. The catalyst material of claim 4, wherein the chalcogen containing group is MₙXₘ where M=Pt and X=S.

14. The catalyst material of claim 4, wherein the chalcogen containing group is MₙXₘ where M=Pt and X=S.

15. The catalyst material of claim 14, wherein Pt, and S are present in the atomic ratio Pt:S=2:1.

16. The catalyst material of claim 4, wherein the chalcogen containing group is MₙXₘ where M=Pt and X=Te.

17. The catalyst material of claim 16, wherein Pt, and Te are present in the atomic ratio Pt:Te=2:1.

18. The catalyst material of claim 4, wherein the chalcogen containing group is MₙXₘ and the catalyst material comprises 10-30 wt % of MₙXₘ and 70-90 wt % of particulate carbon.

19. The catalyst material of claim 3, wherein the organometallic clusters adsorbed on the carbon support are heat-treated in an inert atmosphere.

20. The catalyst material of claim 19, wherein the organometallic clusters adsorbed on the carbon support are heat-treated in an atmosphere of argon.

21. A methanol tolerant electrocatalyst material comprising a heat-treated chalcogenide adsorbed onto an electrically conductive component, said chalcogenide including the group of MₙFeₚXₘ, MₙXₘ, MₙClₚXₘ, or mixtures thereof wherein M=Pt, Ru or Re, X=S, Se or Te, and m, n and p=1 or 2,

22. The catalyst material of claim 21 comprising a chalcogenide having a di-facial nano-structured configuration.

23. A method for producing a catalyst material comprising
(a) mixing together:
(1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures of MₙFeₚXₘ, MₙXₘ, and MₙClₚXₘwherein M=Pt, Ru or Re, X=S, Se or Te, and m, n and p=1 or2,
(2) an electrically conductive component, and
(3) an organic solvent, such that the clusters are adsorbed on the electrically conductive component;
(b) removing the solvent; and
(c) in a non-oxidizing atmosphere, heat-treating of the clusters adsorbed on the electrically conductive component at a temperature of at least 175° C.
